(19) United States
(12) Patent Application Publication
(10) Pub. No.: US 2015/0154759 A1
(43) Pub. Date: Jun. 4, 2015

(54) METHOD, IMAGE PROCESSING DEVICE, AND COMPUTER PROGRAM PRODUCT

(71) Applicant: Kabushiki Kaisha Toshiba, Tokyo (JP)

(72) Inventor: Io Nakayama, Akishima-shi (JP)

(21) Appl. No.: 14/328,966

(22) Filed: Jul. 11, 2014

(30) Foreign Application Priority Data
Nov. 29, 2013 (JP) 2013-247866

(51) Int. Cl. G06T 7/20; G06T 5/00; G06T 5/50; H04N 5/14

(52) U.S. Cl. CPC G06T 7/2006; H04N 5/145; G06T 5/001; G06T 5/50; G06T 2207/10016; G06T 2207/20004

(57) ABSTRACT

According to one embodiment, a method of processing image data using a processor includes acquiring a motion history of areas of a frame image based on motion information for the areas determined by frame images comprised in one of scenes of a video and identifying a plurality of areas each having a similar motion as object areas comprising a same object.

### CROSS-REFERENCE TO RELATED APPLICATIONS

This application is based upon and claims the benefit of priority from Japanese Patent Application No. 2013-247866, filed on Nov. 29, 2013, the entire contents of which are incorporated herein by reference.

### FIELD

Embodiments described herein relate generally to a method, an image processing device, and a computer program product.

### BACKGROUND

As an image quality improvement technique, there has conventionally been known a technique that identifies an object attracting a lot of attention in one scene of a video and performs different image processing depending on whether in an attractive area in which the object is located or in the other area thus changing intensity in an image in the video. When the image is a static image, it is possible to identify the attractive area in the image from a result of detecting a face in the image or a distance from the center of the image to the object.

However, when the image is a moving image, it is necessary to consider consistency of a target frame for identifying the attractive area with a previous or next frame. Furthermore, because there exists the possibility that an object in the moving image moves, it is also necessary to consider the motion of the same object in a scene.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram illustrating one example of a functional configuration of an image processing device according to a present embodiment;

FIG. 2 is an exemplary block diagram illustrating one example of a functional configuration of an attention-degree calculator in the present embodiment;

FIGS. 3A to 3D are exemplary views for explaining image processing in the present embodiment;

FIG. 4 is an exemplary view illustrating a state that areas are integrated in the present embodiment;

FIG. 5 is an exemplary view illustrating one example of image quality improvement processing in the present embodiment;

FIG. 6 is an exemplary view illustrating one example of the image quality improvement processing in the present embodiment; and

FIG. 7 is an exemplary flowchart illustrating one example of procedures of the image processing in the present embodiment.

### DETAILED DESCRIPTION

In general, according to one embodiment, a method of processing image data using a processor comprises acquiring a motion history of areas of a frame image based on motion information for the areas determined by frame images comprised in one of scenes of a video and identifying a plurality of areas each having a similar motion as object areas comprising a same object.

Hereinafter, embodiments are explained with reference to the accompanying drawings. An image processing device according to an embodiment is applied to a reproducing device that decodes and reproduces video data stored in a storage medium such as a hard disk drive (HDD), a digital versatile disc (DVD), or a Blu-ray (registered trademark) disc. However, the present embodiment is not limited to these examples.

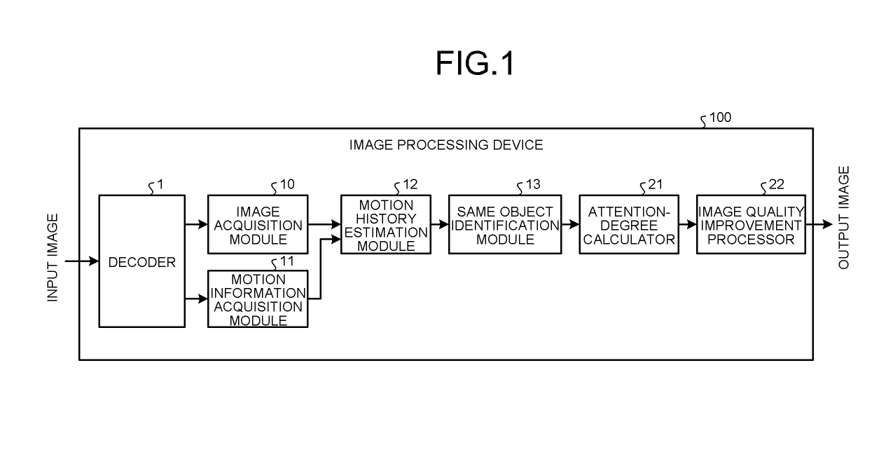

An image processing device 100 in the present embodiment is, as illustrated in FIG. 1, mainly provided with a decoder 1, an image acquisition module 10, a motion information acquisition module 11, a motion history estimation module 12, a same object identification module 13, an attention-degree calculator 21, and an image quality improvement processor 22.

The decoder 1 inputs video data encoded as input images therein from a storage medium such as a HDD or a DVD to decode the video data. In this case, the decoder 1 decodes the video data and, at the same time, generates motion vectors as motion information. Here, the decoder 1 generates the motion vectors for each predetermined area in a frame that constitutes the video data. The predetermined area is a macro block when the encoding system is in accordance with ITU-T Recommendation H.264, and a prediction unit (PU) when the encoding system is in accordance with ITU-T Recommendation H.265/High Efficiency Video Coding (HEVC). However, the predetermined area is not limited to these examples.

The image acquisition module 10 acquires frame images that constitute the video of a target scene in video data decoded. Here, the scene indicates a series of shots in the video data and, for example, a video recorded during the period from the start of a video camera by pushing a record button to the stop of the video camera. However, the scene is not limited to this example.

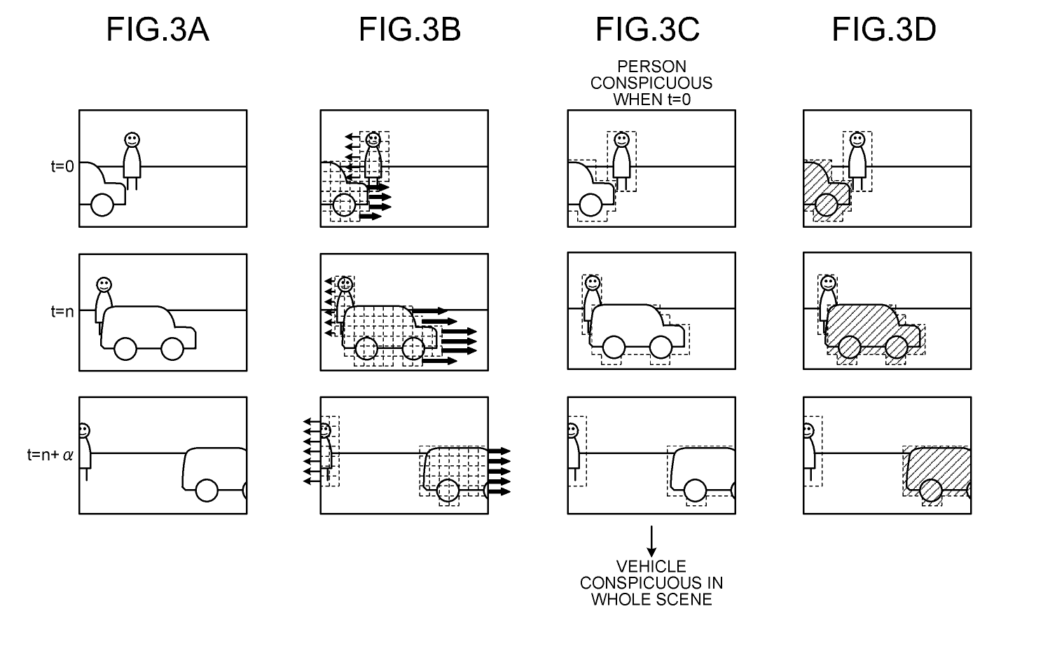

Each of FIGS. 3A to 3D illustrates frame images that constitute a target scene in video data at each process in image processing. Here, each of FIGS. 3A to 3D illustrates frame images arranged in time-series order from above to below such that a frame image when t (time)=0, a frame image when t=n, and a frame image when t=n+a are arranged in this order. The image acquisition module 10 acquires the frame images illustrated in FIG. 3A.

The motion information acquisition module 11 acquires motion vectors for each area of the frame image from the decoder 1. Here, in FIG. 3B, arrows in each area indicate motion vectors. In FIG. 3B, the rectangular range surrounded by dotted lines indicates a predetermined area. Here, for the convenience sake of explanation, in FIGS. 3A to 3D, the motion vectors are omitted partly.

The motion history estimation module 12 acquires the motion history of each area through the frame images based on the motion vectors in each area included in the frame images that constitute the video of the target scene in the video data. To be more specific, the motion history estimation module 12 traces the motion vectors in the frame images of the video in one scene thus estimating the history of the motion of the area moved in the scene. For example, as can be understood from FIG. 3B in spite of the difference in motion quantity of the motion vectors, the area including a vehicle always moves left to right in a screen.

The same object identification module 13 integrates, with reference to the motion history estimated in the motion history estimation module 12, a plurality of areas adjacent to each other in which the motion is similar as object areas indicative of a plurality of areas that constitute a same object to identify the same object. Here, similar motion corresponds to the case that the directions of the motion vectors are identical with each other, for example. However, examples of the motion are not limited to this case.

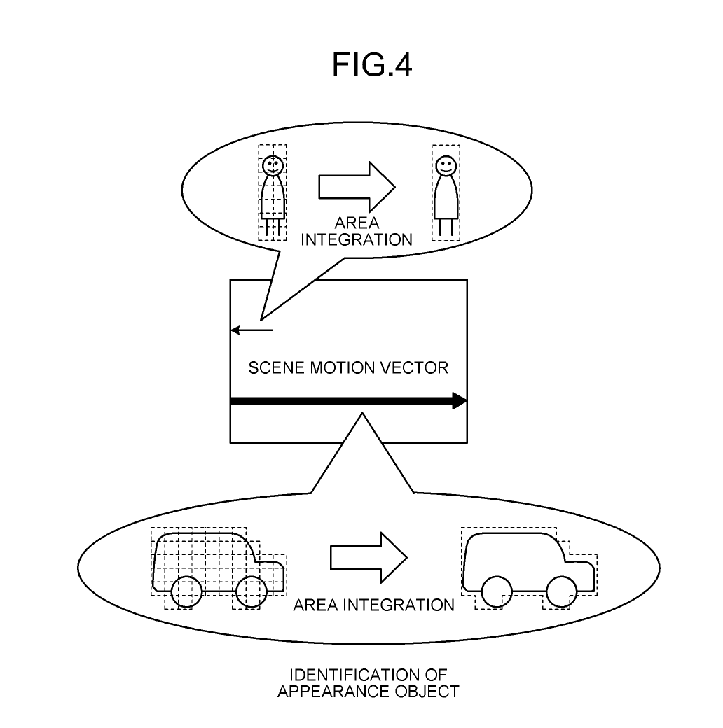

FIG. 3C illustrates a state that the plurality of areas of the same object are integrated as the object area. In FIG. 3C, an area surrounded by dotted lines indicates the object area of the same object. In an example in FIG. 3C, the object area of a person and the object area of a vehicle are identified. FIG. 4 illustrates a state that areas of each of a person and a vehicle are integrated.

The attention-degree calculator 21 calculates an attention degree indicative of the degree of attention in a scene with respect to an object area identified by the same object identification module 13 based on the size of the object area, the distance from the center of a frame image to the object area, and the motion quantity of an object.

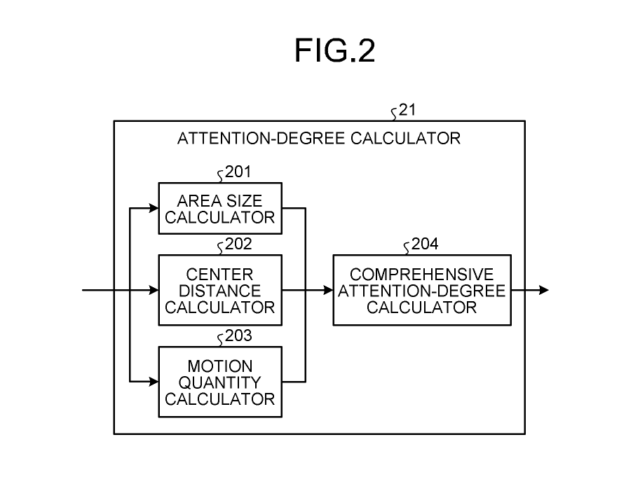

The attention-degree calculator 21 is, as illustrated in FIG. 2, provided with an area size calculator 201, a center distance calculator 202, a motion quantity calculator 203, and a comprehensive attention-degree calculator 204.

The area size calculator 201 calculates the size of an object area identified in a frame image for each frame image. The area size calculator 201 calculates the number of pixels that constitute the object area as the size of the object area.

The center distance calculator 202 calculates a distance (center distance) from the center position of a frame image; that is, a screen, to an object area for each frame image. The center distance calculator 202 calculates the Euclidean distance between the center of gravity of the object area and the center of the screen.

The motion quantity calculator 203 calculates the motion quantity of an object area that exists in a frame image for each frame image by using motion vectors. The motion quantity calculator 203 calculates, for example, the average value of the motion vectors in a macro block comprised in the object area as the motion quantity.

The comprehensive attention-degree calculator 204 calculates the attention degree of each object area in a target scene based on the center distance, the size of the area, and the motion quantity. A viewer is liable to easily catch sight of a large object and hence, it is conceivable that a larger size of the object area results in a higher attention degree. Furthermore, generally, the viewer views the center area of a screen in many cases and hence, it is conceivable that the shorter the distance between the center of the screen and the object is, the higher the attention degree becomes. In addition, generally, the viewer is liable to easily catch sight of an object moving quickly and hence, it is conceivable that a larger motion quantity results in a higher attention degree.

Accordingly, the comprehensive attention-degree calculator 204 calculates the attention degree so as to be a higher value along with an increase in the size of the object area in the frame image that is calculated in the area size calculator 201, the attention degree so as to be a higher value along with a decrease in the center distance, and the attention degree so as to be a higher value along with an increase in the motion quantity.

To be more specific, the comprehensive attention-degree calculator 204 first calculates the attention degree of an object area in each frame image in a target scene. An attention degree R of each frame image is calculated by the following expression (1); that is, a weighting addition using weight coefficients β, γ, and δ. Here, a size of an object area that is calculated in the area size calculator 201 is expressed as A. A center distance calculated in the center distance calculator 202 is expressed as B. Motion quantity calculated in the motion quantity calculator 203 is expressed as C.

R=βA+γB+δC (1)

Furthermore, the comprehensive attention-degree calculator 204 calculates a total value of attention degrees of the respective frame images in the target scene as a comprehensive attention degree in the scene.

In the example in FIG. 3C, in the frame image when t=0, a person is close to the center of the screen compared with a vehicle. In consideration of this frame image only, the person is higher in attention degree than the vehicle. However, in subsequent frame images when t=n and t=n+α, the object area of the vehicle is close to the center of the screen compared with the person, the area size of the vehicle is also larger than that of the person and hence, the comprehensive attention-degree calculator 204 calculates so that in the whole scene, the attention degree of the vehicle becomes higher than that of the person. In FIG. 3D, the object area of the vehicle being high in attention degree is illustrated by being hatched.

The image quality improvement processor 22 performs image quality improvement processing with respect to an object area based on the attention degree calculated in the attention-degree calculator 21. Here, the image quality improvement processor 22 is one example of an image processor. In the present embodiment, the image quality improvement processor 22 performs image quality improvement processing different depending on the attention degree in such a manner that the higher the attention degree is, the higher the image quality becomes, for example.

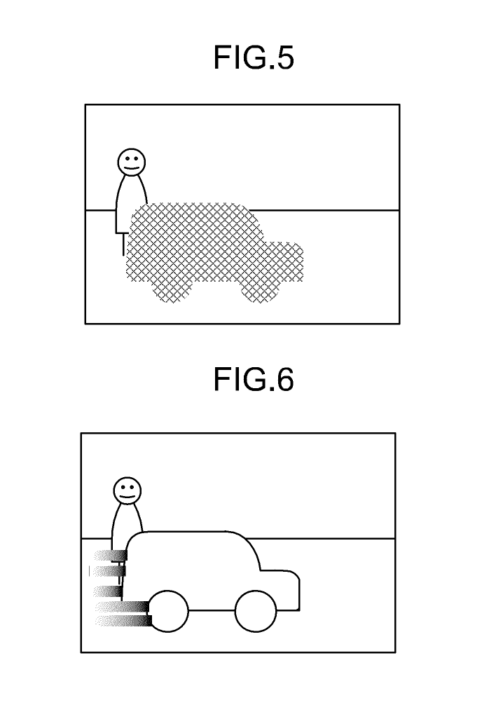

For example, the image quality improvement processor 22 enhances, as illustrated in FIG. 5, the contrast of an object area (vehicle in the example in FIG. 5) being high in attention degree thus further enhancing the liveliness of the object. Furthermore, for example, in the case of an object with large motion (vehicle in the example in FIG. 6) as illustrated in FIG. 6, the image quality improvement processor 22 does not perform processing of enhancing sharpness of the object area of the object but daringly performs an image processing of blurring or the like in the direction in which the object moves. Accordingly, it is possible to increase a sense of speediness and enhance the liveliness of the object. Here, the image quality improving processing is not limited to these examples.

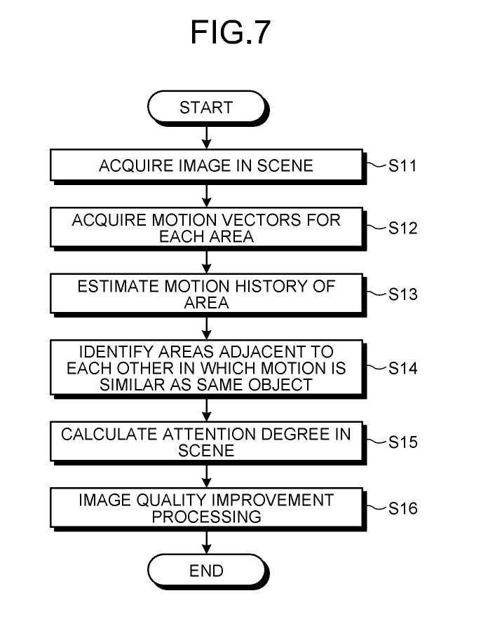

Next, image processing by the image processing device 100 according to the present embodiment that is constituted as above is explained in conjunction with FIG. 7.

First of all, the image acquisition module 10 acquires a frame image of a target scene in video data from the decoder 1 (S11). Furthermore, the motion information acquisition module 11 acquires motion vectors of the target scene in the video data from the decoder 1 for each area (S12).

Next, the motion history estimation module 12 estimates the motion history of an area from the motion vectors for each area (S13). Next, from the motion history, the same object identification module 13 identifies areas adjacent to each other in which the motion is similar as the same object and integrates the areas as an object area (S14).

Next, the attention-degree calculator 21 calculates the attention degree of the object area in a scene as described above (S15). Furthermore, the image quality improvement processor 22 performs image quality improvement processing different depending on the attention degree with respect to the image of the object in the scene (S16).

In this manner, in the present embodiment, with respect to frame images that constitute a certain scene of a video, the motion history of an area is acquired through the frame images based on the motion vectors for each area that are acquired by decoding processing performed by the decoder 1 to identify a plurality of areas in which the motion is similar as an object area indicative of a plurality of areas that constitute the same object. Accordingly, according to the present embodiment, it is possible to estimate accurately the same object in the certain scene in the video.

Furthermore, in the present embodiment, an attention degree in a scene is calculated with respect to an object area and image quality improvement processing is performed based on the attention degree with respect to the object area. Accordingly, according to the present embodiment, motion estimation processing is unnecessary, which it is possible to identify the attractive area also in a video with a small amount of throughput to thereby perform appropriate image processing.

Here, the present embodiment calculates one value as a comprehensive attention degree in a scene and performs a comparable level of image quality improvement processing in each frame image with respect to the object area of the same object. However, the present embodiment is not limited to this example. For example, the image quality improvement processor 22 may be configured such that image quality improvement processing is altered depending on the attention degree of each frame image. For example, the object area of a vehicle when t=n in an example illustrated in FIG. 3 can be set higher in image quality because of the highest attention degree thereof and set lower in image quality when t=0 or t=n+α, thus giving variation in image quality in the scene.

Furthermore, the present embodiment uses motion vectors acquired by the decoder 1 as motion information. However, the present embodiment is not limited to this example. Any information with respect to motion that is acquired by the decoding processing in the decoder 1 can be used optionally.

Furthermore, in the present embodiment, the image quality improvement processing is named as image processing. However, the present embodiment is not limited to this example. Any image processing corresponding to the attention degree can be applied to the present embodiment.

In addition, the present embodiment is applied to image processing in reproducing video data stored in a storage medium. However, the present embodiment is not limited to this example. The present embodiment can also be applied to video data acquired in real time.

The image processing device 100 according to the present embodiment is provided with a controller such as a central processing unit (CPU), a storage device such as a read-only memory (ROM) or a random access memory (RAM), an external storage device such as a hard disk drive (HDD) or a compact disc (CD) drive, a display device such as a display, and an input device such as a keyboard or a mouse.

An image processing program executed in the image processing device 100 according to the present embodiment is embedded and provided as a computer program product in the ROM, for example.

The image processing program executed in the image processing device 100 according to the present embodiment may be recorded and provided as a computer program product in a computer-readable storage medium such as a compact disc read-only memory (CD-ROM), a flexible disk (FD), a compact disc recordable (CD-R), and a digital versatile disc (DVD), as an installable or executable file.

The image processing program executed in the image processing device 100 according to the present embodiment may be stored in a computer connected to a network such as the Internet and provided as a computer program product by being downloaded via the network. Furthermore, the image processing program executed in the image processing device 100 according to the present embodiment may be provided or distributed via a network such as the Internet.

The image processing program executed in the image processing device 100 according to the present embodiment is constituted of modules comprising the above-mentioned respective modules (the image acquisition module 10, the motion information acquisition module 11, the motion history estimation module 12, the same object identification module 13, the attention-degree calculator 21, and the image quality improvement processor 22). The central processing unit (CPU) reads out the program from the above-mentioned ROM to execute the image processing program, and thus the above-mentioned respective modules are loaded on a RAM, and the image acquisition module 10, the motion information acquisition module 11, the motion history estimation module 12, the same object identification module 13, the attention-degree calculator 21, and the image quality improvement processor 22 are generated on the RAM.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method of processing image data using a processor comprising:
acquiring a motion history of areas of a frame image based on motion information for the areas determined by frame images comprised in one of scenes of a video; and
identifying a plurality of areas each having a similar motion as object areas comprising a same object.

2. The method of claim 1, further comprising:
calculating an attention degree of the object areas in a scene so as to set the attention degree to a first value along with a decrease in a distance from a center position of each of the frame images to the object areas.

3. The method of claim 1, further comprising:
calculating an attention degree of the object areas so as to set the attention degree to a first value along with an increase in a size of the object areas in each of the frame images.

4. The method of claim 1, further comprising:
calculating an attention degree of the object areas so as to set the attention degree to a first value along with an increase in motion quantity of the object areas.

5. The method of claim 2, further comprising:
performing image processing with respect to the object areas based on the attention degree.

6. An image processing device comprising:
an estimation controller configured to acquires a motion history of areas of a frame image based on motion information for the areas determined by frame images comprised in one of scenes of a video; and
an identification controller configured to identify a plurality of areas each having a similar motion as object areas comprising a same object.

7. The image processing device of claim 6, further comprising:
a calculator configured to calculate an attention degree of the object areas so as to set the attention degree to a first value along with a decrease in a distance from a center position of each of the frame images to the object areas.

8. The image processing device of claim 6, further comprising:
a calculator configured to calculate an attention degree of the object areas so as to set the attention degree to a first value along with an increase in a size of the object areas in each of the frame images.

9. The image processing device of claim 6, further comprising:
a calculator configured to calculate an attention degree of the object area so as to set the attention degree to a first value along with an increase in motion quantity of the object area.

10. The image processing device of claim 7, further comprising:
an image processor configured to perform image processing with respect to the object areas based on the attention degree.

11. A computer program product having a non-transitory computer readable medium including programmed instructions, wherein the instructions, when executed by a computer, cause the computer to perform:
acquiring a motion history of areas of a frame image based on motion information for the areas determined by frame images comprised in one of scenes of a video; and
identifying a plurality of areas each having a similar motion as object areas comprising a same object.

12. The computer program product of claim 11, the instructions further causing the computer to execute:
calculating an attention degree of the object areas so as to set the attention degree to a first value along with a decrease in a distance from a center position of each of the frame images to the object areas.

13. The computer program product of claim 11, the instructions further causing the computer to execute:
calculating an attention degree of the object areas so as to set the attention degree to a first value along with an increase in a size of the object areas in each of the frame images.

14. The computer program product of claim 11, the instructions further causing the computer to execute:
calculating an attention degree of the object areas so as to set the attention degree to a first value along with an increase in motion quantity of the object areas.

15. The computer program product of claim 12, the instructions further causing the computer to execute:
performing image processing with respect to the object areas based on the attention degree.
